(19) United States
(12) Patent Application Publication
(10) Pub. No.: US 2005/0122421 A1
(43) Pub. Date: Jun. 9, 2005

(54) Photographing apparatus with lighting function

(75) Inventors: Takahiro Ogawa, Saitama (JP); Yukio Uenaka, Tokyo (JP); Nobuhito Nakayama, Tokyo (JP); Shuzo Seo, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/001,042

(22) Filed: Dec. 2, 2004

(30) Foreign Application Priority Data
Dec. 3, 2003 (JP) P2003-404251
Dec. 3, 2003 (JP) P2003-404276

(51) Int. Cl. H04N 5/222

(52) U.S. Cl. 348/370

(57) ABSTRACT

A lighting apparatus includes a plurality of light sources, and a light-source controller. The light-source controller controls the plurality of light sources so that at least one light source in the plurality of light sources can emit assisting light to form contrasts of luminance on a photographic subject, and so that the light sources can simultaneously emit illuminating light to illuminate the photographic subject uniformly. And a photographing apparatus includes the lighting apparatus, a line sensor, and a distance measurer. The line sensor forms image signals corresponding to an image of the photographic subject by receiving the reflected light of the assisting light or the illuminating light reflected by the photographic subject. The distance measurer measures a distance to the subject based on the image signals formed by the line sensor. The line sensor and a high-luminance area formed by emission of the assisting light, cross each other on a plane including the light receiving surface of the line sensor.

### BACKGROUND OF THE INVENTION

1. Field of the Invention

The present invention relates to a photographing apparatus with a lighting function and auto focusing (AF) function, such as digital cameras.

2. Description of the Related Art

Recently, a smaller amount of light than before is required for illuminating objects with a lighting apparatus, because of improvements of sensitivity of silver-halide films and charge coupled devices. Therefore, even though the amount of light output by LEDs is smaller than that output by conventional xenon tubes, usage of LEDs as lighting apparatus for photographing is proposed for improved lighting efficiency, reduced power consumption, and increased life.

On the other hand, in the active AF method, LEDs having high lighting efficiency are used as light sources.

In the case where an assisting light source independent of a strobe-flash is provided, the total photographing device becomes large, and has a complex structure. And generally, the assisting light source emits light only in a predetermined pattern, therefore, high-luminance areas formed on a subject, can not be changed according to the situation of the subject.

### SUMMARY OF THE INVENTION

Therefore, an object of the present invention is to provide a photographing apparatus using a plurality of LEDs as light sources, having a simple structure, and having a lighting function for emitting illuminating light to illuminate an entire photographing area uniformly, and emitting assisting light used for AF in various patterns.

A lighting apparatus according to the present invention, includes a plurality of light sources, and a light-source controller that controls the plurality of light sources so that at least one light source in the plurality of light sources can emit assisting light to form contrasts of luminance on a photographic subject, and so that the light sources can simultaneously emit illuminating light to illuminate the photographic subject uniformly.

The light-source controller may control the plurality of light sources to form a high-luminance area on the photographic subject by emitting the assisting light, the high-luminance area having a higher luminance than the other areas on the subject, and being long and narrow.

A photographing apparatus, according to the present invention, includes the lighting apparatus mentioned above, a line sensor and a distance measurer. The line sensor forms image signals corresponding to an image of the photographic subject by receiving reflected light of the assisting light or the illuminating light reflected by the photographic subject. The distance measurer measures a distance to the subject based on the image signals formed by the line sensor. Here, the high-luminance area and the line sensor cross each other on a plane including the light receiving surface of the line sensor.

The line sensor may extend in a horizontal direction, that is a width direction of the photographing apparatus, and the light-source controller may control the plurality of light sources so that at least one of the high-luminance areas having a horizontal length equaling that of the illuminating area of one of the plurality of light sources, and extending in a perpendicular direction, is formed.

The plurality of light sources can be arranged in a matrix manner to form a shape which is a similar shape to the photographing area of the photographing apparatus.

The photographing apparatus can further include a distance judging device that judges whether the distance measured by the distance measurer can be used for focusing or not. In this case, the light-source controller may control the plurality of light sources so that the assisting light is emitted again by at least partially different light sources to the light sources that emitted the assisting light previously, when it is judged that the distance can not be used for focusing.

The photographing apparatus can further include a memory that stores light-source emission combinations for emitting the assisting light.

The plurality of light sources may include LEDs.

A photographing apparatus, according to another aspect of the present invention, includes the lighting apparatus mentioned above, an imaging device, a contrast detector, and a focusing system. The imaging device generates image signals corresponding to an image of the photographic subject by receiving reflected light of the assisting light and the illuminating light reflected by the photographic subject. The contrast detector detects contrast of the image signals generated by the imaging device. The focusing system focuses on the photographic subject based on the contrast.

In the photographing apparatus, at least one light source in the plurality of light sources may emit the assisting light.

The photographing apparatus can further include, a focus judging device that judges whether the photographic subject is in focus or not when the assisting light is emitted. In this case, the light-source controller may control the plurality of light sources so that a combination of light sources for emitting the assisting light and intensity of the assisting light, is different from combinations used in previous emissions of the assisting light, when it is judged that the subject is not in focus.

The photographing apparatus can further include a memory that stores combinations of light-source emission patterns and intensities for emitting the assisting light.

### BRIEF DESCRIPTION OF THE DRAWINGS

The present invention will be better understood from the description of the preferred embodiment of the invention set forth below together with the accompanying drawings, in which:

FIG. 1 is a front view of a digital camera of the first embodiment;

FIG. 2 is a block diagram of the digital camera of the first embodiment;

FIG. 3 is a conceptual view of the photographing area illuminated by the illuminating light;

FIG. 4 is a view representing an example of assisting light emission;

FIG. 5 is a view representing the photographing area in which the assisting light is emitted;

FIG. 6 is a conceptual view of the luminance distribution on the photographic subject when the assisting light is emitted;

FIG. 7 is a flowchart of a light emission control routine;

FIG. 8 is a block diagram of the digital camera of the second embodiment;

FIG. 9 is a conceptual view of the photographing area of the second embodiment illuminated by the illuminating light;

FIG. 10 is a view representing an example of the assisting light emission of the second embodiment;

FIG. 11 is a conceptual view of the luminance distribution in a horizontal direction, on the photographic subject when the assisting light is emitted;

FIG. 12 is a conceptual view of the luminance distribution in a perpendicular direction, on the photographic subject when the assisting light is emitted; and

FIG. 13 is a flowchart of a light emission control routine of the second embodiment.

### DESCRIPTION OF THE PREFERRED EMBODIMENTS

Hereinafter, the preferred embodiments of the present invention are described with reference to the attached drawings.

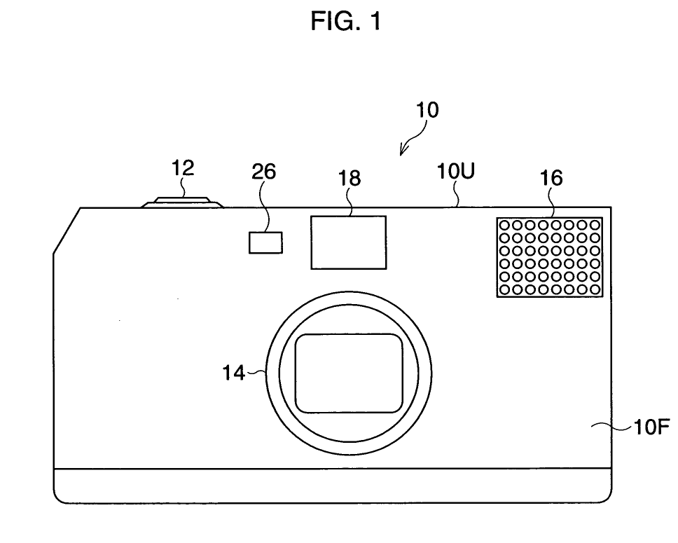

FIG. 1 is a front view of a digital camera of the first embodiment of the present invention.

A digital camera 10 has a release button 12 on an upper surface 10U, and has a photographing optical system 14, a view finder 18, a CCD line sensor 26, and a lighting apparatus 16 on a front surface 10F. The lighting apparatus 16 has a plurality of lighting units including LEDs emitting white light, as light sources. The lighting units are arranged in a matrix manner, 6 rows and 8 columns, corresponding to the shape of the photographing area of the digital camera 10. Light emission intensities for all lighting units can be modulated respectively.

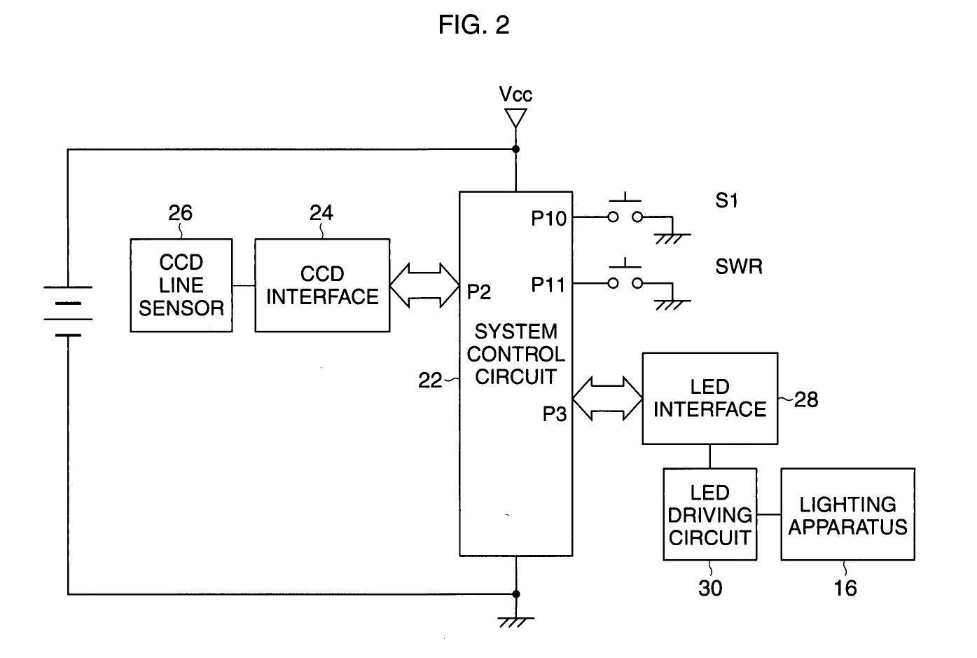

FIG. 2 is a block diagram of the digital camera 10 of the first embodiment.

A system control circuit 22 controls the whole digital camera 10. A distance-measuring switch S1 and a release switch SWR are connected to the system control circuit 22 respectively. The distance-measuring switch S1 is turned on when the release button 12 is half depressed, and a distance to an object is measured for auto-focusing (AF). In an object distance measuring action, first, image signals according to the photographic subject are generated in a CCD line sensor 26 provided for the AF. The CCD line sensor 26 has a plurality of imaging devices, and is arranged along a horizontal direction, that is parallel to the upper surface 10U. And then, the image signals are transmitted to the system control circuit 22, via a CCD interface 24. In the system control circuit 22, the distance to the subject is measured by phase contrast method, based on the image signals generated in the CCD line sensor 26.

When the luminance is too small, a subject image can not be detected under the natural light and the object distance can not be measured, therefore, the object distance measuring action is repeated. That is, control signals to make the lighting unit 16 emit assisting light, are transmitted from the system control circuit 22 to an LED driving circuit 30 via an LED interface 28. The LED driving circuit 30 controls the lighting apparatus 16 so that some of the lighting units of the lighting apparatus 16, arranged in columns, emit assisting light simultaneously with a predetermined intensity, based on the control signals. A high-luminance area having a higher luminance than the other areas, and being long and narrow, is formed by the assisting light, on the surface of the photographic subject.

When reflected light of the assisting light reflected by the high-luminance area, is received by the light-receiving surface of the CCD line sensor 26, the reflected light and the light-receiving surface of the CCD line sensor 26 cross each other on a plane including light-receiving surface of the CCD line sensor 26. Therefore, intensity of a part of the image signals generated in the CCD line sensor 26, becomes higher, and a large contrast output is detected. Based on the large contrast output, the focusing position is calculated, and a lens in the photographing optical system 14, is moved by a lens driving circuit (not shown) to the focused position.

Data indicating which lighting units emit assisting light, and the intensities of assisting light emitted by the lighting units, are stored temporally in the system control circuit 22. When it is judged by the system control circuit 22, that the distance to the subject is not measured although the assisting light has been emitted by the lighting apparatus 16, assisting light will be emitted again. In this case, control signals for controlling the lighting apparatus 16 are transmitted from the system control circuit 22, to the LED driving circuit 30, so that lighting units at least partially different from the lighting units previously used to emit assisting light, emit assisting light. This is because changing the combination of lighting units that emit the assisting light, may make the distance measuring possible. Data indicating which lighting units emit assisting light, is memorized in the system control circuit 22, every time the distance measuring fails, and is deleted when the distance measuring has succeeded. Assisting light emission by the lighting apparatus 16, is repeated until the distance is measured by the system control circuit 22.

When the release button 12 is fully pressed, the release switch SWR is turned on. When the release switch SWR is turned on, a shutter is opened to adjust exposure at a predetermined aperture for a predetermined time, based on the control signal from system control circuit 22. And then a CCD (not shown) is exposed.

In this case, when the illuminating mode, that is the mode for illuminating a subject for any photographing time, is set, or when the luminance of the subject measured by a photometry-measuring sensor (not shown) is smaller than the predetermined amount, the amount of illuminating light necessary is calculated by the system control circuit 22 according to the distance to the photographic subject, and the lighting apparatus 16 illuminates the photographic subject. In this case, all lighting units of the lighting apparatus 16 emit illuminating light because the entire photographic subject should be illuminated. On the other hand, when the illuminating mode is not set, or the luminance of the subject is large enough, the lighting apparatus 16 does not emit illuminating light.

When the CCD (not shown) is exposed, electric charge according to the image, that is, image signals are produced. The image signals successively read from the CCD, are transmitted to the system control circuit 22 after amplifying processes, digitalizing processes, white balance adjustments, and gamma corrections.

Image signals transmitted to the system control circuit 22, are further transmitted to the LCD driving circuit (not shown). An LCD (not shown) is driven based on the image signals, (not shown) and the subject image is displayed on the LCD. The image data of the photographed subject are memorized in the DRAM (not shown) or a memory card (not shown). Note that not only still pictures, but also moving pictures can be displayed on the LCD based on the image signals generated by the exposure of the CCD.

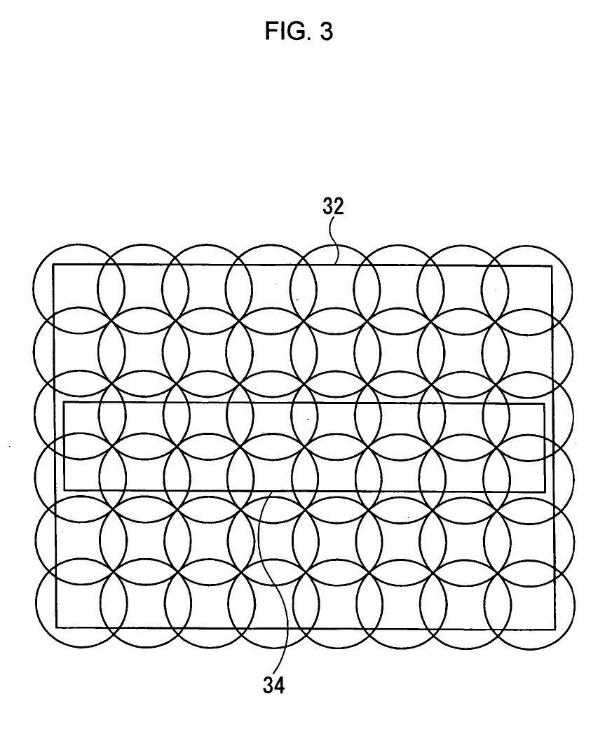

FIG. 3 is a conceptual view of the photographing area illuminated by the illuminating light.

Illuminating light emitted by each of the lighting units arranged in a matrix manner according to the aspect ratio 3:4 of the photographing area of the digital camera 10, has a predetermined illuminating angle. Therefore, the lighting apparatus 16 can illuminate a subject in the photographing area uniformly, and when the light emission intensities for all the lighting units are the same, such as in strobe flashing, all of the subject is illuminated under the constant luminance.

A distance measuring area 34 extends in a horizontal direction and is located at the center of the photographing area 32. When reflected light reflected by the photographic subject in the distance measuring area 34 corresponding to the CCD line sensor 26, is received by the CCD line sensor 26, the distance to the subject is measured. Note that the distance measuring area 34 has an extremely short length in the perpendicular direction, although it is exaggerated in FIG. 3.

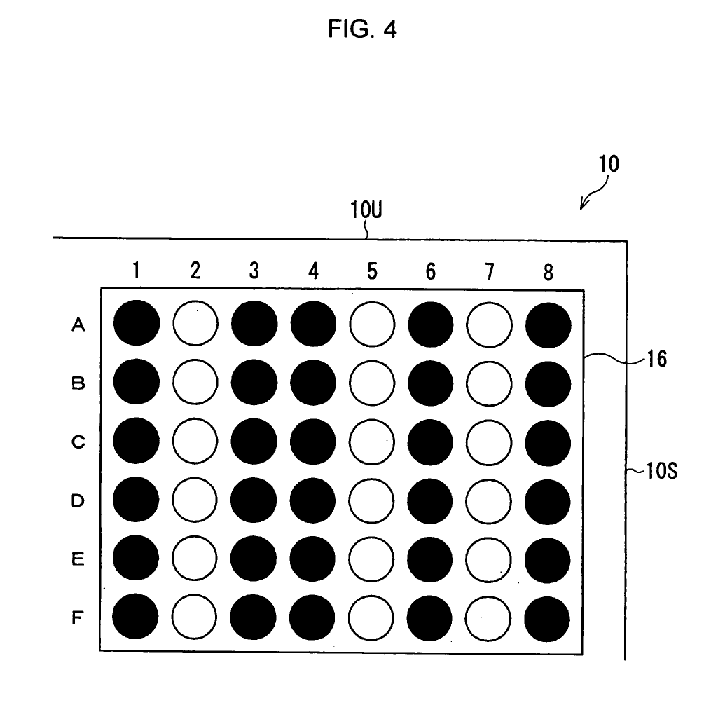

FIG. 4 is a view representing an example of assisting light emission.

To distinguish each of the lighting units arranged in 6 rows parallel to the upper surface 10U, and 8 columns parallel to a side surface 10S of the digital camera 10, all of the lighting units are expressed as A to F rows and 1 to 8 columns. For example, the lighting unit located at the upper left corner in FIG. 4, is A1, and the one neighboring it on the right, is A2, and the one located in the lower right corner is F8. The emission intensities of all the lighting units are controllable respectively, and here, all of the lighting units in the columns 2,5, and 7, that is the lighting units A2-F2, A5-F5, and A7-F7, emit assisting light with the same emission intensity.

As mentioned above, the lighting apparatus 16 can emit not only the illuminating light used for photographing, but also the assisting light used for measuring distance. Therefore, the structure of the digital camera 10 can be simplified because an assisting light source independent of the digital camera 10, for AF, is unnecessary.

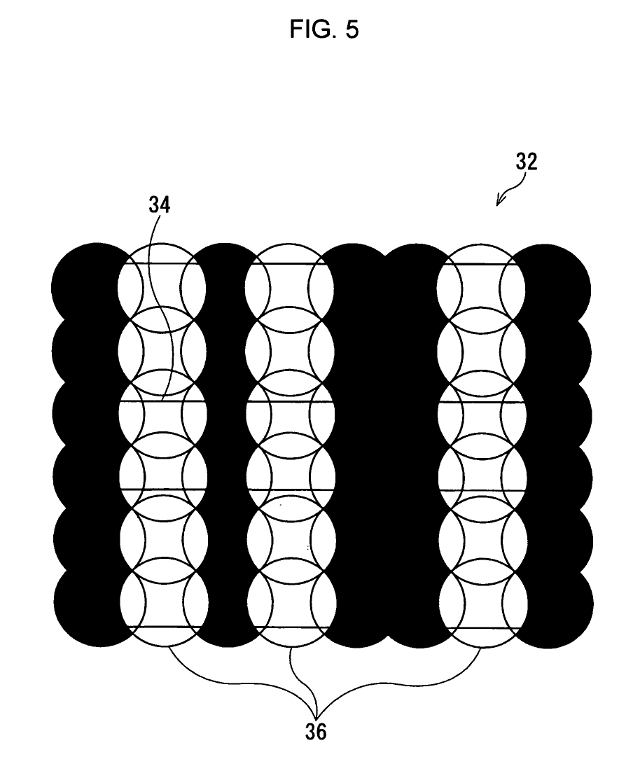

FIG. 5 is a view representing the photographing area 32 in which the assisting light shown in FIG. 4 is emitted.

When the assisting light is emitted by the lighting units in the columns 2,5, and 7 at the same intensity as mentioned above, high-luminance areas 36 orthographically crossing the distance measuring area 34, are formed. Each of the high-luminance areas 36 is long and narrow, that is, each of the high-luminance areas 36 has a horizontal width equaling that of the illuminating area of one of the lighting units, and extends in a vertical direction. The reason that the assisting light is emitted to form such high-luminance areas 36 orthographically crossing the distance measuring area 34, is to measure the distance to the photographic subject efficiently, by partially forming narrow higher luminance zones in the distance measuring area 34.

When the high-luminance area 36 and the distance measuring area 34 are parallel, the high-luminance area 36 is not included in the distance measuring area 34 at all, or the entire high-luminance area 36 is included in the distance measuring area 34. In the former case, there is no effect on measuring distance by emitting assisting light, and in the latter case, intensity of the image signals generated in the CCD line sensor 26 becomes higher uniformly, and no contrast output is detected. On the other hand, when the assisting light is emitted to form a high-luminance area 36 crossing the distance measuring area 34 at a slope, contrast can not be detected sufficiently because many neighboring imaging devices of the CCD line sensor 26 receive the reflected light from the high-luminance area 36.

The distance measuring areas 34 can be formed to have a shape of a plurality of lines by using a plurality of the CCD line sensors 26. For example, in addition to the distance measuring area 34 shown in FIG. 5, another distance measuring area 34 running through the center of the photographing area 32 and extending in a perpendicular direction, can be formed to create a cross shaped distance measuring area 34. Further, an “H” shaped distance measuring area 34 can also be made, that is formed by adding two linear distance measuring areas 34 in a vertical direction at the edge of the distance measuring area 34 in the horizontal direction shown in FIG. 4. These distance measuring areas 34 are useful when changing the direction of the digital camera 10 for photographing, or when a photographic subject is in the peripheral area of the photographing area 32. In any case, the assisting light is emitted so that the high-luminance areas 36 are orthographically crossing the distance measuring areas 34.

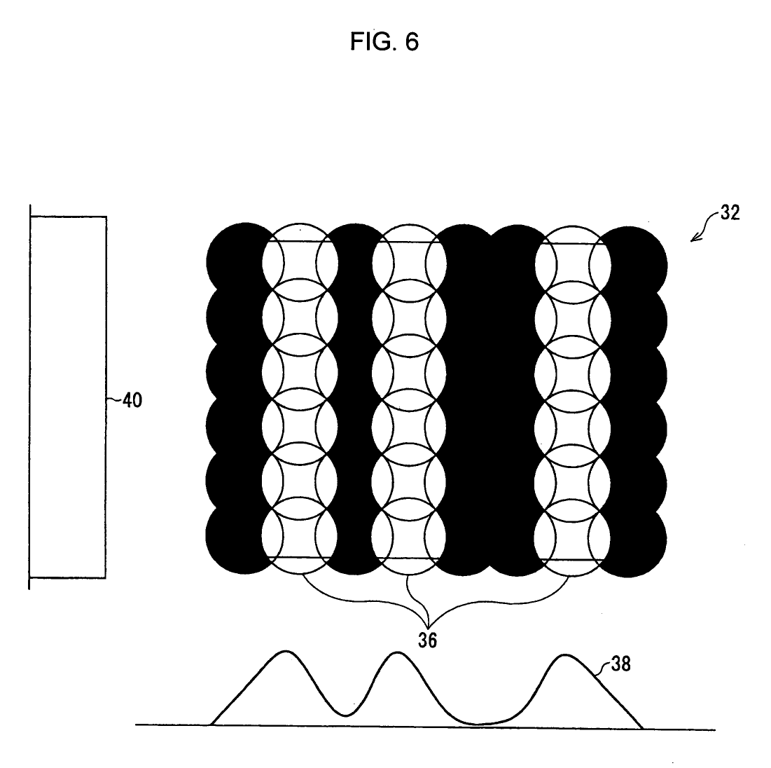

FIG. 6 is a conceptual view of the luminance distribution on the photographic subject when the assisting light is emitted as shown in FIG. 4.

When the high-luminance areas 36 are formed by the assisting light emitted by the lighting units in the columns 2,5, and 7 at the same intensity, the luminance distribution in the horizontal direction is as shown by the peaks 38 (a higher peak means a higher luminance). On the other hand, the luminance distribution in a vertical direction is constant over the entire photographing area 32 as shown by the peaks 40. When the distance to the photographic subject can not be measured using only natural light and the lighting apparatus 16 emits the assisting light, the luminance of the subject is generally small. Even in such a situation, emitting assisting light to form the high-luminance area 36 on the surface of the photographic subject, crossing the distance measuring area 34 orthographically as shown in FIG. 5 and FIG. 6, can make the distance measurement easier by making the intensity of the image signals partially higher and enhancing the contrast, when the reflected light reflected by the subject is received by the CCD line sensor 26.

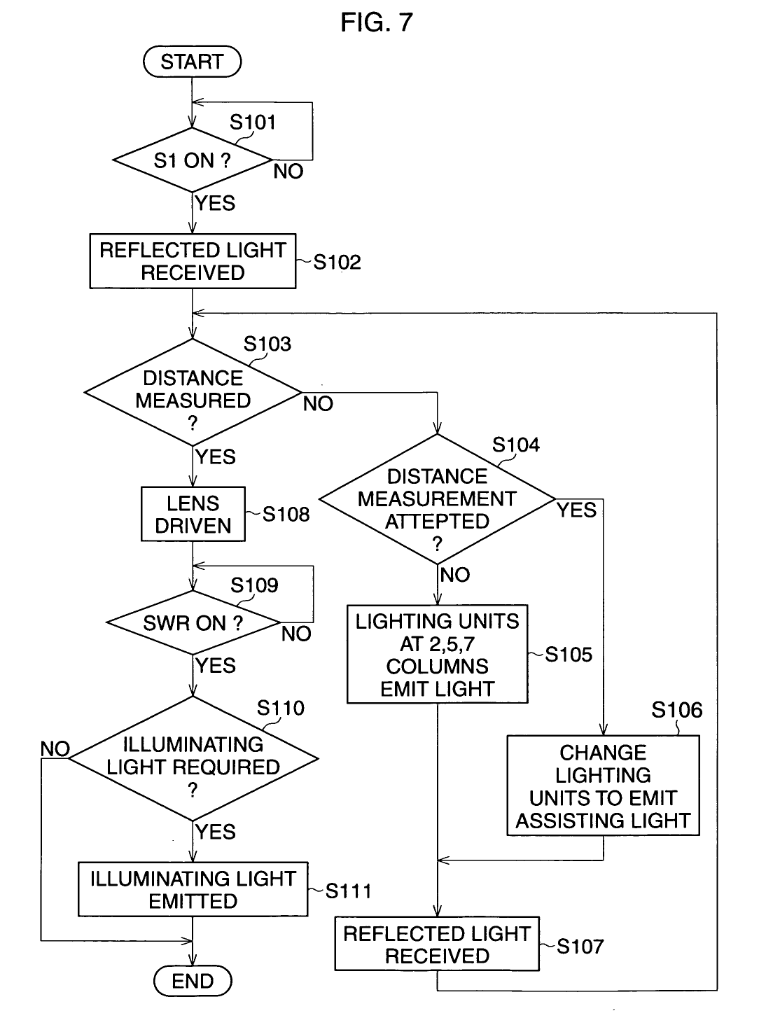

FIG. 7 is a flowchart representing a light emission control routine for the assisting light and the illuminating light, by the lighting apparatus 16.

At step S101, it is judged whether the distance-measuring switch S1 is turned on or not. The step S101 is repeated until it is judged that the distance-measuring switch S1 is turned on. At step S102, light reflected by the photographic subject is received by the CCD line sensor 26, and then the process proceeds to step S103.

At step S103, it is judged whether the distance to the subject can be measured or not, that is, whether the image signals generated by the CCD line sensor 26 and the distance data calculated by the system control circuit 22 can be used for AF or not (i.e., whether reliable distance data is obtained or not). This judgment is carried out by comparing the contrast value obtained using the data output from the CCD line sensor 26, and a predetermined contrast value. When it is judged that the distance is measured correctly, the control proceeds to step S108, and when it is judged that the distance is not measured correctly, the control proceeds to step S104.

At step S104, it is judged whether the assisting light has already been emitted to attempt the distance measurement and the distance measurement has failed or not, that is, it is judged whether the data regarding the lighting units having emitted the assisting light is memorized in the system control circuit 22 or not. When it is judged that the distance measurement has not yet been attempted, the control proceeds to step S105. And when it is judged that the distance measurement has already been attempted and failed, the control proceeds to step S106.

At step S105, the assisting light is emitted by the lighting units that are predetermined to emit the assisting light for the first distance measurement, and then the control proceeds to step S107. Here, the lighting units to emit the assisting light for the first time can be freely set, although the lighting units in the columns 2,5, and 7 are set to emit the assisting light first, in this first embodiment.

At step S106, a different combination of lighting units from the combinations that were previously used, is selected to emit the assisting light, so as to avoid the failed combination, and to emit the assisting light efficiently. That is, data regarding the combinations of the lighting units already used to emit the assisting light are searched by the system control circuit 22, and a new combination having a different light emission pattern from the patterns already used, is selected. In the selection, combinations having exactly the same arrangement of the lighting units as the combinations already used, and also combinations with a similar arrangement, such as those having the same distances between lighting units as the failed combinations, are not selected. For example, after the assisting light emitted by the lighting units in the columns 2,5, and 7, the combination of the lighting units in the columns 1,4, and 6, or the columns 3,6, and 8 are not selected because these combinations have the same distances between lighting units and light emission patterns as the combination of the 2,5, and 7 columns. In this example, a combination of the lighting units at 1,3, and 7 columns can be selected as having a new light emission pattern. When the assisting light is emitted by the lighting units included in the newly selected combination, the control proceeds to step S107.

At step S107, light reflected by the photographic subject is received by the CCD line sensor 26, and the control proceeds to step S103.

At step S108, the photographing lens in the photographing optical system 14 is driven and a photographic subject is focused. And step S109, it is judged whether the release switch SWR is turned on or not, and the judgment is repeated until it is judged that the release switch SWR is turned on. When it is judged the release switch SWR is on, the control proceeds to step S110.

At step S110, it is judged whether the illuminating light is emitted when photographing, or not. When the illuminating mode for emitting the illuminating light every photographing time is set, or when the luminance of the photographic subject measured by a photometry-measuring sensor (not shown) is smaller than the predetermined amount, it is judged that emitting illuminating light is required, and the control proceeds to step S111. On the other hand, when it is judged that emitting illuminating light is not required, the light emission control routine ends.

At step S111, the amount of the illuminating light is calculated by the system control circuit 22 according to the distance to the photographic subject, and the lighting apparatus 16 illuminates the photographic subject. In this case, all the lighting units A1-F8 of the lighting apparatus 16 emit illuminating light with the same intensity, because the entire photographic subject should be illuminated uniformly. When the illuminating light is emitted, the light emission control routine ends.

When it is judged that the distance measurement has already been attempted and failed at step S104, the control may proceed to step S105 to attempt the same combination of the lighting units again, although the control proceeds to step S106 to change the combination of the lighting units in this embodiment. In this case, it is necessary to judge how many times the same combination failed at step S104, and when the number of failure times reaches the predetermined maximum number of failure times for the same combination, the control should proceed to step S106 to change the failed combination.

In the first embodiment mentioned above, a photographing apparatus has a lighting function for emitting illuminating light to illuminate a photographic subject and emitting assisting light in various patterns for AF, and has a simple structure. The photographing apparatus can easily measure a distance to a photographic subject, differing from conventional cameras using assisting light sources, because the lighting apparatus 16 of the photographing apparatus can automatically change a combination of lighting units to emit assisting light when the previous distance measurement has failed due to unsuitable conditions. And the lighting apparatus 16 can be used for photographing apparatuses having different shapes of the distance measuring area 34 from that in the first embodiment, because the lighting units to emit the assisting light can be changed according to the shapes of the distance measuring area 34.

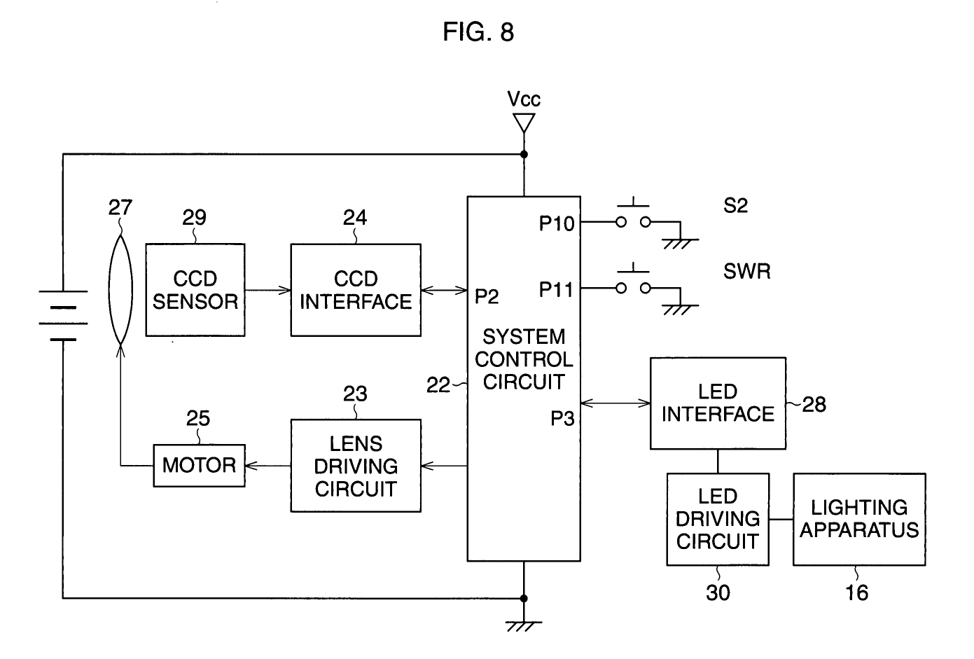

Hereinafter, the second embodiment of the present invention is described with reference to the attached FIGS. 8 to 13 and the difference to the first embodiment is explained. In these following figures, the same components as those in the first embodiment, have the same reference numerals.

FIG. 8 is a block diagram of the digital camera 10 of the second embodiment.

In this second embodiment, a CCD sensor 29 having a plurality of imaging devices is provided. The CCD sensor 29 is used for both AF and generating image signals according to a photographic subject, although in the first embodiment, the CCD line sensor 26 is used for measuring distance for AF and another CCD is used for generating image signals according to a photographic subject.

An auto-focusing switch S2 and a release switch SWR are connected to the system control circuit 22 respectively. When the release button 12 is half depressed the auto-focusing switch S2 is turned on, and an auto-focusing (AF) action is carried out. In the AF action, first, image signals according to the photographic subject are generated by the CCD sensor 29. And then, the image signals are transmitted to the system control circuit 22, via a CCD interface 24. In the system control circuit 22, a contrast is detected based on luminance data of part of the image signals, and is memorized.

Further, driving signals for driving a motor 25 to slightly move a photographing lens 27, are transmitted from the system control circuit 22 to a lens driving circuit 23. After the photographing lens 27 has been slightly moved based on the driving signals, a contrast is detected again, and the contrast is memorized in the system control circuit 22. Data of the slightly changing contrasts are memorized after repeating the detection of the contrast after changing the position of the photographing lens 27. And the position of the photographing lens 27 in which the contrast is maximum in the memorized data, is set as a focused position.

When the contrast of luminance is too small, the AF action can not be carried out. Therefore, some of the lighting units of the lighting apparatus 16, emit assisting light with a predetermined intensity based on the control signals transmitted from the system control circuit 22 to the LED driving circuit 30 via the LED interface 28. The emission of the assisting light makes the contrast of the image signals generated by the CCD sensor 29 larger, and makes the AF action easy, because contrasts of luminance on a photographic subject are formed. Note that in this second embodiment, emission of the assisting light is not limited to the lighting units arranged on columns, although the lighting units arranged in columns emit assisting light in the first embodiment.

After data indicating which lighting units emit assisting light, and the intensities of the assisting light are memorized, and when it is judged by the system control circuit 22 that the AF action is not finished although the assisting light has been emitted by the lighting apparatus 16, the assisting light will be emitted again. In this case, control signals for controlling the lighting apparatus 16 are transmitted from the system control circuit 22 to the LED driving circuit 30, so that the combination of lighting units to emit the assisting light and the intensities of the assisting light, are changed from the combinations in previous emissions of the assisting light. This is because changing the combination of lighting units to emit the assisting light and intensities of the assisting light, may accomplish the AF action. Data indicating the combination of the lighting units emit assisting light and the intensities of the assisting light is memorized in the system control circuit 22, every time the AF action fails, and is deleted when the AF action has succeeded. Assisting light emission by the lighting apparatus 16, is repeated until the contrast of image signals is detected by the system control circuit 22 and the AF action is accomplished.

Note that in this second embodiment, the emission intensities of the assisting light are not always constant, although the emission intensity is constant in the first embodiment.

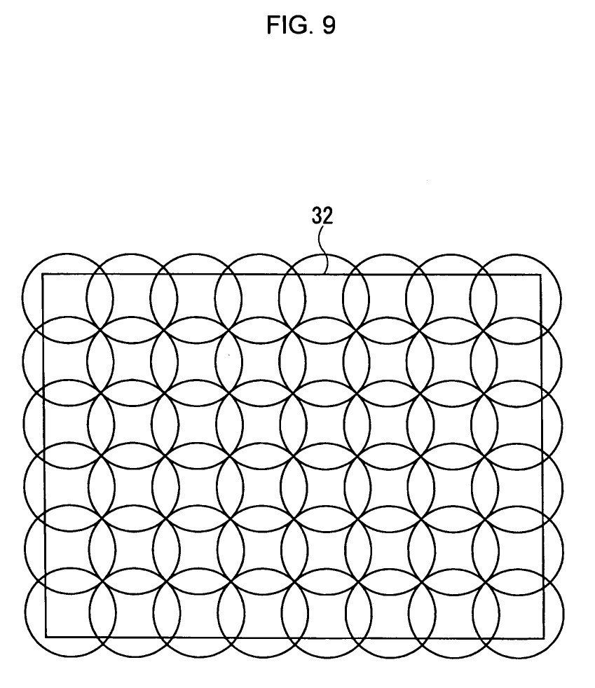

FIG. 9 is a conceptual view of the photographing area of the second embodiment illuminated by the illuminating light.

The distance measuring area 34 does not exist in this second embodiment, because the CCD line sensor 26 in the first embodiment is not provided. However, the lighting apparatus 16 of this second embodiment can illuminate a subject in the photographing area 32 uniformly, by emitting the illuminating light, totally the same as in the first embodiment.

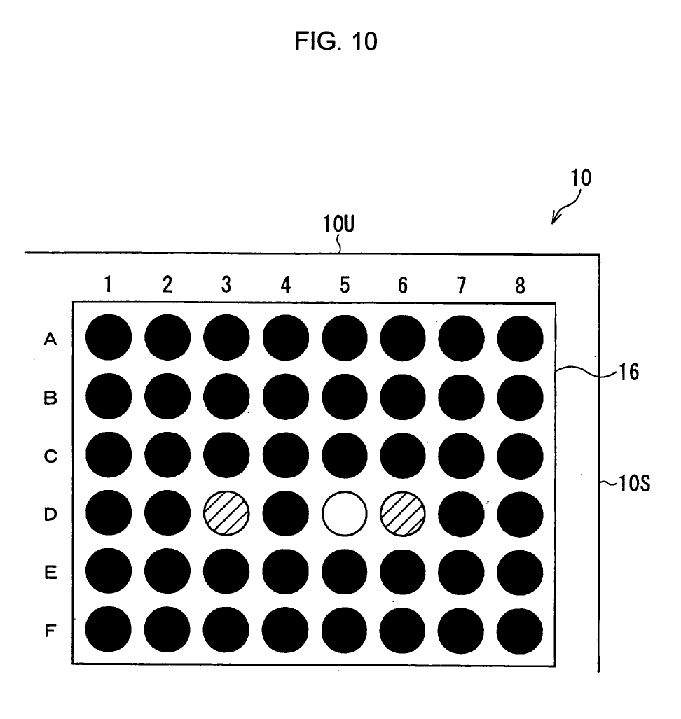

FIG. 10 is a view representing an example of assisting light emission of the second embodiment.

The emission intensity of each lighting unit can be set in two steps. In the example shown in FIG. 10, the lighting units D3, D5, and D6 emit assisting light, the intensity of the assisting light emitted by the lighting units D3 and D6 is low, and the intensity of the assisting light emitted by the lighting unit D5 is high.

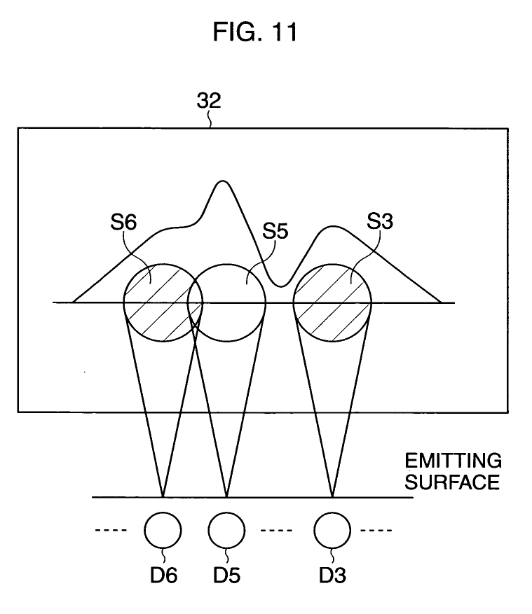

FIG. 11 is a conceptual view of the luminance distribution in a horizontal direction, on the photographic subject when the assisting light is emitted as shown in FIG. 10.

When the assisting light is emitted by the lighting units D3, D5, and D6, a partial photographic subject in the partial photographing area S5 that is a part of the photographing area 32, is illuminated brightly. On the other hand, each partial photographic subject in the partial photographing areas S3 and S6 is illuminated less brightly than the partial photographic subject in the partial photographing area S5. Therefore, the luminance distribution in the horizontal direction (of D row) is as shown by the peaks (a higher peak means a higher luminance). Thus, the contrast of the photographic subject in the photographing area 32 is enhanced.

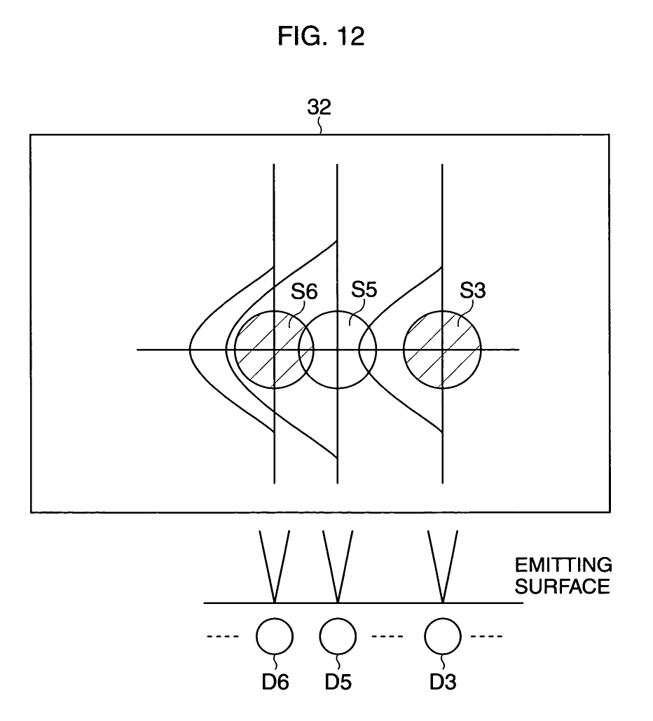

FIG. 12 is a conceptual view of the luminance distribution in a perpendicular direction, on the photographic subject when the assisting light is emitted as shown in FIG. 10.

When the assisting light is emitted by the lighting units D3, D5, and D6, the luminance of the partial photographing areas S3, S5, and S6 becomes higher than the other areas, and the luminance distribution in the perpendicular direction is as shown by the peaks (a higher peak means a higher luminance). When the AF action is not accomplished under natural light and the lighting apparatus 16 emits the assisting light, the contrast of luminance of the photographic subject is generally small. Even in such a situation, emitting assisting light having partially different brightness to form a pattern of luminance difference on subject as shown in FIG. 11 and FIG. 12, can help the AF action.

Note that emission of the assisting light is not limited to the lighting units arranged in the same row, although the lighting units arranged in the same row emit assisting light in the second embodiment. Emission of the assisting light by the lighting units arranged on different rows and columns, can form contrast of luminance on subject in a wide area.

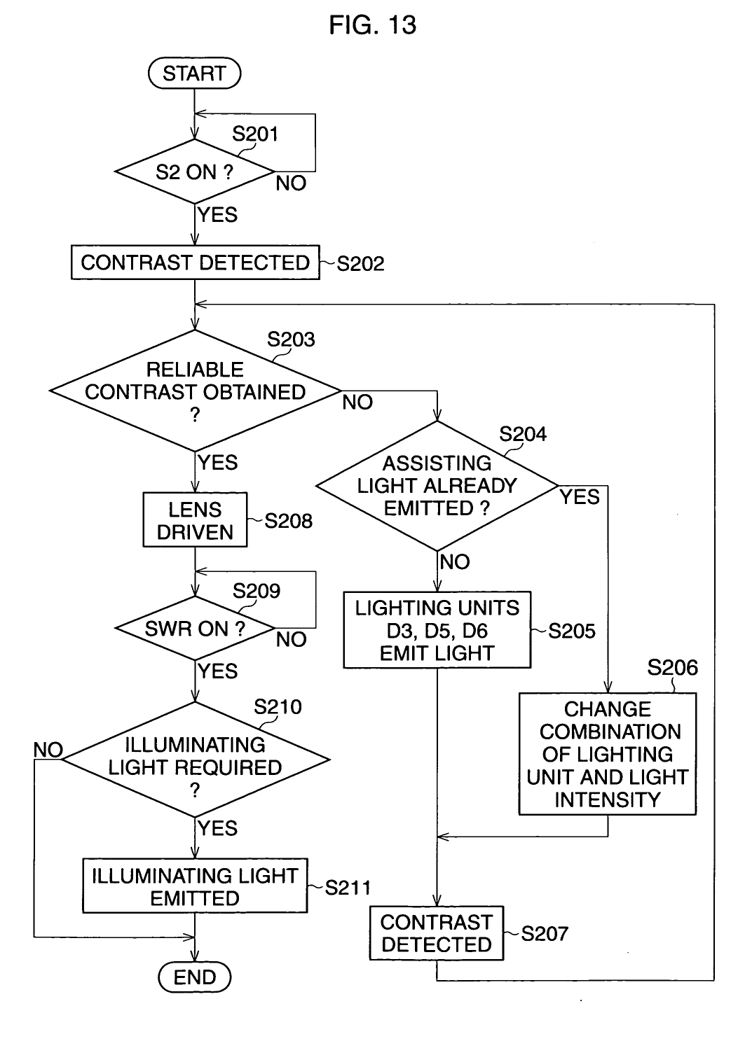

FIG. 13 is a flowchart representing a light emission control routine of the assisting light and the illuminating light, of the second embodiment.

At step S201, it is judged whether the auto-focusing switch S2 is turned on or not. Step S201 is repeated until it is judged that the auto-focusing switch S2 is turned on. At step S202, the contrast of the image signals according to the photographic subject, generated by the CCD sensor 29, is detected. Then the control proceeds to step S203.

At step S203, it is judged whether a contrast exists or not, that is, whether there is a contrast having higher value than the predetermined value, and reliable contrast data is obtained or not is judged. When it is judged that a useful contrast has been detected, the control proceeds to step S208, and when it is judged that a useful contrast has not been detected, the control proceeds to step S204.

At step S204, it is judged whether the assisting light has already been emitted to attempt the AF action and if the AF action has failed or not, that is, it is judged whether the data regarding the lighting units emitted the assisting light has been memorized in the system control circuit 22 or not. When it is judged that the AF action has not yet been attempted, that is the assisting light has not been emitted, the control proceeds to step S205. And when it is judged that the AF action has already been attempted and failed, the control proceeds to step S206.

At step S205, the assisting light is emitted by the lighting units that are predetermined to emit the assisting light for the first AF action, and then the control proceeds to step S207. Here, the emission intensity of the lighting units D3 and D6 is set low, and intensity of the lighting unit D5 is set high. However, the combination of the lighting units to emit the assisting light and emission intensities can be set freely.

At step S206, a different combination of lighting units for emitting the assisting light and intensities of the assisting light, from the combinations that were previously used, is selected randomly by the system control circuit 22, after detecting the memorized data representing previously used combinations. The assisting light is emitted in a newly selected combination, and the control proceeds to step S207.

At step S207, contrast of the image signals generated by the CCD sensor 29 is detected, and the control proceeds to step S203.

At step S208, the photographing lens 27 is driven based on the detected contrast. And at step S209, it is judged whether the release switch SWR is turned on or not, and the judgment is repeated until it is judged that the release switch SWR is turned on. When it is judged that the release switch SWR is on, the control proceeds to step S210.

At step S210, it is judged whether the illuminating light is emitted when photographing, or not. When the illuminating mode for emitting the illuminating light every photographing time is set, or when the luminance of the photographic subject measured by the photometry-measuring sensor is smaller than the predetermined amount, it is judged that emission of the illuminating light is required, and the control proceeds to step S211. On the other hand, when it is judged that emission of the illuminating light is not required, the light emission control routine ends.

At step S211, the amount of the illuminating light is calculated by the system control circuit 22 according to the distance to the photographic subject, and the lighting apparatus 16 illuminates the photographic subject. In this case, all lighting units A1-F8 of the lighting apparatus 16 emit illuminating light at high intensity, because the entire photographic subject should be illuminated uniformly. When the illuminating light is emitted, the light emission control routine ends.

When it is judged that the AF action has already been attempted and failed at step S204, the control may proceed to step S206 to attempt the same combination of lighting units and intensities of the assisting light again, although the control proceeds to step S206 to change the combination of the lighting units and intensities in this embodiment. In this case, it is necessary to judge how many times the same combination has failed at step S204, and when the number of failure times reaches the predetermined number of failure times for the same combination, the control should proceed to step S206 to change the failed combination.

In the second embodiment mentioned above, the photographing apparatus has a lighting function for emitting illuminating light to illuminate photographic subject and for emitting assisting light used for AF in various patterns, and also has a simple structure.

The selection of the lighting units to emit the assisting light is not limited to those in the both embodiments. For example, considering the first embodiment, any combinations of the lighting units to form the high-luminance areas 36 orthographically crossing, can be used. Further, not all of the lighting units on the column need to emit the assisting light as far as forming the high-luminance areas 36 crossing the distance measuring area 34.

In terms of the second embodiment, lighting units in the same column, or lighting units on a diagonal line can emit the assisting light. In any cases, the distance between the lighting units that emit the assisting light can be set freely. Further, the lighting units for emitting the assisting light can be selected randomly, and only one lighting unit may emit the assisting light. In addition to this, lighting units for emitting the assisting light can be selected from ones located in a plurality of areas, for example in the multiple auto focus method, and selection of the lighting units may be according to the photographing modes. The emission intensities of the assisting light, are not limited to the two steps in the second embodiment, further steps can be set. On the other hand, only one step can be set, that is, luminance of the assisting light may be distinguished by only lighting or not lighting of the lighting units, although the emission intensity is preferably modulated.

Although each of the lighting units has the LED as a light source, other light sources in which the light emission intensity is adjustable, for example electric lamps and so on, can be used as light sources.

The arrangement of the lighting units in the lighting apparatus 16 is not limited to those in the embodiments. For example, lighting units arranged in a matrix manner of 3 rows in the horizontal direction and 4 columns in the vertical direction along the front surface 10F, according to the aspect ratio 3:4 of the photographing area of the digital camera 10, or 9 rows and 16 columns, can be used. In these cases, each of the lighting units emits light in a predetermined direction and at a predetermined illuminating angle to illuminate the entire photographing area. Further, the arrangement of the lighting units is not limited to a matrix structure, that is, the lighting units can be arranged on other polygons or a circle.

The lighting apparatus 16 can be used not only with a digital camera 10, but also with cellular phones with photographing functions, and so on. And the lighting apparatus 16 can be detachably attached to the camera body and can be controlled by received control signals from the system control circuit 22, differing from forming one body as shown in these embodiments.

Finally, it will be understood by those skilled in the art that the foregoing description is of a preferred embodiments of the apparatus, and that various changes and modifications may be made to the present invention without departing from the spirit and scope thereof.

The present disclosure relates to subject matters contained in Japanese Patent Application Nos. 2003-404251 (filed on Dec. 3, 2003) and 2003-404276 (filed on Dec. 3, 2003) which are expressly incorporated herein, by reference, in their entirety.

1. A lighting apparatus comprising:
a plurality of light sources; and
a light-source controller that controls said plurality of light sources so that at least one light source in said plurality of light sources can emit assisting light to form contrasts of luminance on a photographic subject, and so that said light sources can simultaneously emit illuminating light to illuminate said photographic subject uniformly.

2. The lighting apparatus according to claim 1, wherein, said light-source controller controls said plurality of light sources to form a high-luminance area on said photographic subject by emitting said assisting light, said high-luminance area having a higher luminance than the other areas on said subject, and being long and narrow.

3. A photographing apparatus comprising:
a lighting apparatus that has a plurality of light sources and a light-source controller, said light-source controller controls said plurality of light sources so that at least one light source in said plurality of light sources can emit assisting light to form a high-luminance area on said photographic subject, said high-luminance area having a higher luminance than the other areas on said subject and being long and narrow, and so that said light sources can simultaneously emit illuminating light to illuminate said photographic subject uniformly;
a line sensor that forms image signals corresponding to an image of said photographic subject by receiving reflected light of said assisting light or said illuminating light reflected by said photographic subject; and
a distance measurer that measures a distance to said subject based on said image signals formed by said line sensor;
wherein, said high-luminance area and said line sensor cross each other on a plane including a light receiving surface of said line sensor.

4. The photographing apparatus according to claim 3, wherein said line sensor extends in a horizontal direction, that is a width direction of said photographing apparatus, and said light-source controller controls said plurality of light sources so that at least one of said high-luminance areas has horizontal length equaling the length of the illuminating area of one of said plurality of light sources, and extending in a perpendicular direction, is formed.

5. The photographing apparatus according to claim 3, wherein said plurality of light sources is arranged in a matrix manner to form a shape which is a similar shape to the photographing area of said photographing apparatus.

6. The photographing apparatus according to claim 3, further comprising:
a distance judging device that judges whether said distance measured by said distance measurer can be used for focusing or not;
wherein, said light-source controller controls said plurality of light sources so that said assisting light is emitted again by at least partially different light sources to said light sources that emitted said assisting light previously, when it is judged that said distance can not be used for focusing.

7. The photographing apparatus according to claim 6, further comprising:
a memory that stores combinations of light-source emission patterns for emitting said assisting light.

8. The lighting apparatus according to claim 1, wherein, said plurality of light sources include light emitting diodes (LEDs).

9. A photographing apparatus comprising:
a lighting apparatus that has a plurality of light sources and a light-source controller, said light-source controller controls said plurality of light sources so that at least one light source in said plurality of light sources can emit assisting light to form contrasts of luminance on a photographic subject, and so that said light sources can simultaneously emit illuminating light to illuminate said photographic subject uniformly;
an imaging device that generates image signals corresponding to an image of said photographic subject by receiving reflected light of said assisting light and said illuminating light reflected by said photographic subject;
a contrast detector that detects contrast of said image signals generated by said imaging device; and
a focusing system that focuses on said photographic subject based on said contrast.

10. The photographing apparatus according to claim 8, wherein said plurality of light sources is arranged in a matrix manner to form a shape which is a similar shape to a photographing area of said photographing apparatus.

11. The photographing apparatus according to claim 9, wherein at least one light source in said plurality of light sources emits said assisting light.

12. The photographing apparatus according to claim 8, further comprising:
a focus judging device that judges whether said photographic subject is in focus or not when said assisting light is emitted;
wherein, said light-source controller controls said plurality of light sources so that a combination of said light sources for emitting said assisting light and the intensity of said assisting light, is different from said combination in a previous emission of said assisting light, when it is judged that said subject is not in focus.

13. The photographing apparatus according to claim 12, further comprising:
a memory that stores combinations of light-source emission patterns and the intensities for emitting said assisting light.
